(19) United States
(12) Patent Application Publication
(10) Pub. No.: US 2004/0201274 A1
(43) Pub. Date: Oct. 14, 2004

(54) Key-operated switch for a motor vehicle

(76) Inventors: Gerd Rudolph, Apisheim (DE); Rreiner Luley, Mainz (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/487,587

(22) PCT Filed: Aug. 16, 2002
(86) PCT No.: PCT/DE02/02993

(30) Foreign Application Priority Data
Aug. 24, 2001 (DE) 10141579.6

(51) Int. Cl. B60L 1/00

(52) U.S. Cl. 307/10.1

(57) ABSTRACT

A key-operated switch for a motor vehicle, especially for activating and deactivating a passenger airbag. The key-operated switch includes a closing cylinder which is arranged in a housing. The rotor of said cylinder is connected to an actuating element by means of a front-side driving element wherein the actuating element is used to actuate main switching contacts associated with fixed contacts. The actuating element is embodied as a rotary switch element including a contact bridge having a plurality of wipers. The wipers are used as main switching contacts and co-operate with contact strips used as fixed contacts.

### TECHNICAL FIELD

### Specification

The invention generally relates to key-operated switches and more particularly relates to key-operated switches for a motor vehicle for switching a passenger airbag on and off.

### BACKGROUND OF THE INVENTION

A disabling, key-operated switch for switching a passenger airbag of a motor vehicle on and off, which comprises a lock cylinder held in a housing with a rotor, is known. The key switch is typically installed in a glove compartment of the motor vehicle and used to disable the passenger side airbag as required. Typically, the same key is shared between the car's ignition and the disabling switch. Disabling the passenger airbag off is necessary, especially if a child's carseat positioned contrary to the travel direction of the motor vehicle is transported on the front passenger seat because deployment of the passenger airbag can cause severe injuries to a child transported in the child's carseat. The lock cylinder of the disabling key switch is designed so that the rotor has an eccentric driver that strikes a microswitch in a switched-on passenger airbag. The microswitch is perpendicular to a printed circuit board and a cam actuates the microswitch in the switching position in which the passenger airbag is disabled. Over extended periods of use, the micro-switch can suffer wear-induced failure, wherein the disabling switch assumes a permanently disabled position.

DE 43 07 711 A1 discloses a key switch that comprises a lock cylinder with a rotor enclosed in a housing. Two drivers spaced away from each other are located on the front face of the rotor, between which there is an actuator with a feeling finger projecting on the peripheral side. Contact springs serving as switch contacts are assigned to the feeling finger on the housing side; they strike corresponding fixed contacts as a function of the rotary position of the rotor, in which case the contact springs and the fixed contacts are perpendicular to the axis of the rotor.

The invention proposes to offer a key switch of the above type that has a sturdy and compact structure.

The proposal is achieved according to the invention in that the actuating element is designed as a rotary switch member with a contact bridge that has several contact arms serving as switching contacts, and the contact arms collaborate with contact paths serving as fixed contacts.

Due to these measures, a redundant key switch is prepared, with which a number of current paths corresponding to the contact arms can be opened and closed, where both an electric consumer is switched on and off and a safety circuit is switched, which assures the particular switching state of the consumer, e.g., a passenger airbag. Furthermore, the actuation of a contact path by means of a contact spring is relatively wear-free. The axially oriented arrangement of the lock cylinder to the rotary switch member without an additional actuating element assures a compact construction of the key switch.

According to an advantageous embodiment of the invention, the contact pathways are resistance-coded and are connected with board electronics. The board electronics supervise the functionality of the contact pathways and also field questions on the switching state. The board electronics can display an indication on the switching state of the consumer assigned to the key switch for the driver of the vehicle on the basis of information, or report a defect in the current paths. Through the resistance coding of the contact pathways and the surveillance by the board electronics, a relatively high security relative to the functionality of the key switch is assured.

The contact pathways are expediently located on a printed circuit board assigned to a base of the housing. The printed circuit board, which can be assigned to additional structural components, is relatively cost-favorable to prepare.

The rotary switch member is preferably contained in a hood-like cover that is fastened on the printed circuit board and which overlaps the front side facing the lock cylinder in an annular manner on the edge. The rotary switch member is thus held rotatably on the printed circuit board in a most dust-protected manner. This embodiment represents an important aspect relative to the assembly of the key switch because it is prepared beforehand without the lock cylinder, and the lock cylinder accommodating an ignition key of a motor vehicle is inserted into the housing during the final assembly of the vehicle. The housing with the rotary switch member held by the cover such that it cannot be lost can be manipulated relatively without problems and the assignment of an individual lock cylinder is possible at any time after the preliminary assembly.

To produce a tactile switching feel for the user of the key switch, it is advantageous to provide the cover with a spring arm pointing in the direction of the rotary switch member; this spring arm locks the rotary switch member into the switching positions of the key switch. The spring arm locking with the rotary switch member in the switching positions also assures a presetting of one of the switching positions in which the key switch is to be found in its assembly in the vehicle.

The rotary switch member preferably has two raised stops spaced away from each other on the front side facing the lock cylinder, on which the spring arm of the cover comes to rest in the corresponding switching positions. The stops of the rotary switch member lie in its ejection direction; therefore, a relatively cost-favorable mold structure results.

In order to arrange the spring arm in the ejection direction of the cover, it is expediently located in the region of the cover that overlaps the rotary switch member annularly.

To assure transfer of the rotation movement of a key inserted in the lock cylinder to the rotary switch member, the driver is advantageously formed eccentrically on the front side of the rotor and has an essentially rectangular cross section that engages in a corresponding recess of the rotary switch member.

Because damage to the rotary switch member is excluded in the assembly of the lock cylinder in the housing, the rotary switch member has an annular projection in its center, on which the driver comes to stop in a position offset to the recess during the assembly of the lock cylinder in the housing.

The printed circuit board is expediently equipped with luminance diodes for back-lighting the symbols of a housing lid.

The housing, housing lid, base, rotary switch member and/or the cover are preferably produced of plastic. A relatively cost-favorable production in the injection molding process is assured by this embodiment.

It is understandable that the above features and those still to be elucidated can be used not only in the combination indicated but also in other combinations without departing from the scope of the present invention.

### BRIEF DESCRIPTION OF THE DRAWINGS

FIG. 1 shows a perspective representation of a key switch according to the invention.

FIG. 2 shows a perspective representation according to FIG. 1 without housing.

FIG. 3 shows a perspective representation according to FIG. 2 without a lock of cylinder.

FIG. 4 shows a perspective representation according to FIG. 3 without the cover.

FIG. 5 shows a perspective representation according to FIG. 4 without the rotary switch member.

FIG. 6 shows a perspective representation according to FIG. 5 without the printed circuit board.

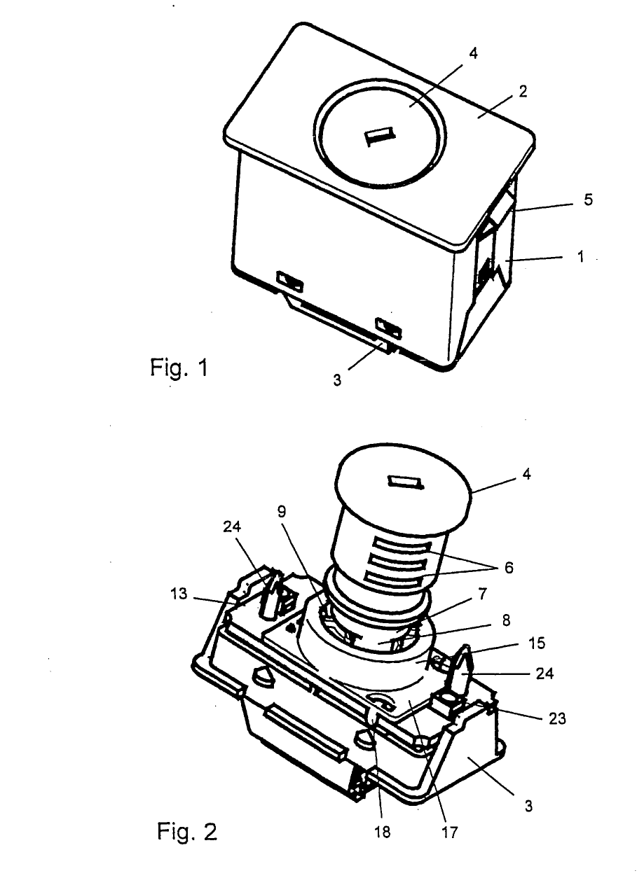

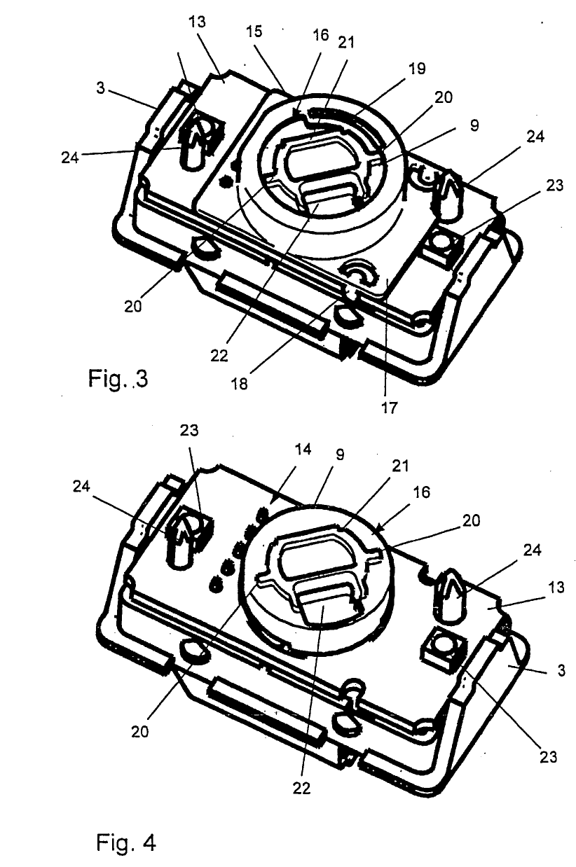

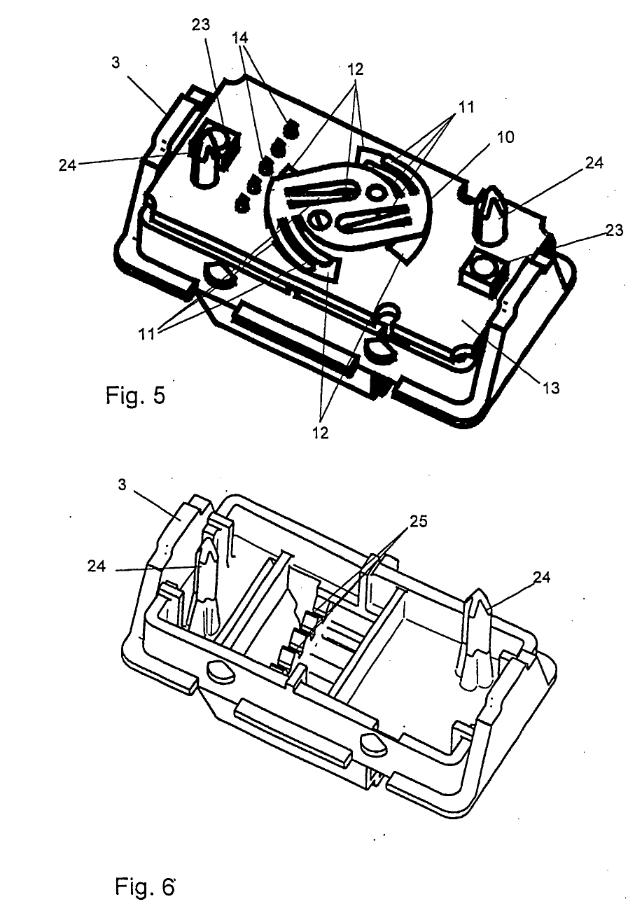

### DETAILED DESCRIPTION OF THE PREFERRED EMBODIMENTS

The key-operated switch involves a housing 1 with a housing lid 2 that protrudes over the housing 1 peripherally, as well as a base 3 that is clipped into the housing 1. The housing 1, essentially rectangular in cross section, which holds a lock cylinder 4, is provided at its opposite narrow sides with leaf spring arms 5 for mounting in an insertion opening. Besides the tumblers 6, the lock cylinder 4 has a rotor 7, on the front side of which a driver 8 essentially rectangular in cross section is eccentrically formed.

The driver 8 resides in a corresponding recess 22 of a rotary switch member 9, where a contact bridge 10 with several contact arms 11 serving as switch contacts is assigned. Driver 8 is rotationally fixed to the rotary switch member 9. The contact arms 11 strike resistance-coded contact pathways 12 serving as fixed contacts and which are formed on a printed circuit board 13 and are connected via connection contacts 14 to board electronics (not shown). The contact arms 11 of the contact bridge 10 of the rotary switch member 9 simultaneously open and close two current circuits for a consumer with a rotation of the rotor 7 of the lock cylinder 4 such that a redundant key switch is involved.

The rotary switch member 9 is placed in a hood-like cover 15 that is fastened on the printed circuit board 13, where the front side 16 of the rotary switch member 9 facing the lock cylinder 4 is annularly overlapped on the edge by the cover 15. The cover has a base plate 17 on which the fastening projections 18 overlapping the printed circuit board 13 are formed. Furthermore, the cover 15 is provided with a spring arm 19 pointing in the direction of the rotary switch member 9 and which locks the rotary switch member 9 in the two switching positions of the key switch staggered by 90° to each other for switching the consumer on and off. Herein the spring arm 19 comes to rest respectively on a raised stop 20 on the front side 16 of the rotary switch member 9 facing the lock cylinder 4. The opposite stops 20 open with their end pointing in the direction of the center of the rotary switch member 9 into an annular projection 21, on which the driver 8 of the rotor 7 of the lock cylinder 4 comes to stop in a position displaced with regard to the recess 22 of the rotary switch member 9 during the assembly of the lock cylinder 4 in the housing 1.

The printed circuit board 13 equipped with two luminous diodes 23 is centered over two centering pins 24 diagonal to each other of the base 3. The base 3 has notches 25 in which each one of the offset connection contacts 14 lies for fixing the offset connection contacts 14 connected with the printed circuit board 13.

1-11 (Canceled)

12. Key-operated switch for a motor vehicle, comprising:
a lock cylinder,
a housing for receiving the lock cylinder, wherein said lock cylinder includes a rotor which is connected through a front side driver to an actuating element for acting on switch contacts assigned to fixed contacts, wherein the actuating element is designed as a rotary switch member with a contact bridge that has a plurality contact arms serving as switch contacts, wherein the contact arms collaborate with contact pathways serving as said fixed contacts.

13. Key switch according to claim 12, wherein the contact pathways are resistance-coded and are connected with board electronics.

14. Key switch according to claim 13, wherein the contact pathways are located on a printed circuit board assigned to a base of the housing.

15. Key switch according to claim 14, wherein the rotary switch member is placed in a cover that is fastened on the printed circuit board and which annularly overlaps a front side facing the lock cylinder on the edge.

16. Key switch according to claims 15, wherein the cover is provided with a spring arm pointing in the direction of the rotary switch member and which locks the rotary switch member in the switching positions of the key switch.

17. Key switch according to claim 16, wherein the rotary switch member has two raised stops spaced away from each other on the front side facing the lock cylinder, at which raised stops the spring arm of the cover comes to stop in the corresponding switching positions.

18. Key switch according to claim 16, wherein, the spring arm is located in the region of the cover that annularly overlaps the rotary switch member.

19. Key switch according to claim 12, wherein the driver is formed eccentrically on the front side of the rotor and has an essentially rectangular cross section that engages in a corresponding recess of the rotary switch member.

20. Key switch according to claim 12, wherein the rotary switch member has an annular projection or ridge in its center, on which the driver comes to stop in a position staggered relative to a recess during the assembly of the lock cylinder in the housing.

21. Key switch according to claim 14, wherein the printed circuit board is equipped with luminous diodes for back-lighting symbols of a housing lid.

22. Key switch according to claim 14, wherein the housing, a housing lid, the base, the rotary switch member and/or the cover are of plastic.
